(19) United States
(12) Patent Application Publication
(10) Pub. No.: US 2023/0308435 A1
(43) Pub. Date: Sep. 28, 2023

(54) AUTHENTICATION SYSTEM, AUTHENTICATION TERMINAL, METHOD FOR CONTROLLING AUTHENTICATION SYSTEM, METHOD FOR CONTROLLING AUTHENTICATION TERMINAL, AND STORAGE MEDIUM

(71) Applicant: NEC Corporation, Minato-ku, Tokyo (JP)

(72) Inventor: Tatsuki AKUTSU, Tokyo (JP)

(73) Assignee: NEC Corporation, Minato-ku, Tokyo (JP)

(21) Appl. No.: 18/011,350

(22) PCT Filed: Jun. 22, 2020
(86) PCT No.: PCT/JP2020/024431

§ 371 Date: Dec. 19, 2022

(51) Int. Cl. H04L 9/40

(52) U.S. Cl. CPC H04L 63/0861

(57) ABSTRACT

Provided is an authentication system that realizes personal authentication having greater convenience. The authentication system includes a terminal held by a user, an authentication server, and an authentication terminal. The authentication server stores first biometric information for performing the biometric authentication of the user, and first terminal authentication information for performing terminal authentication by the terminal. The authentication terminal supports biometric authentication and terminal authentication.

### TECHNICAL FIELD

The present invention relates to an authentication system, an authentication terminal, a method for controlling an authentication terminal, and a storage medium.

### BACKGROUND ART

A so-called employee ID card is often lent to an employee or the like of a company. The employee ID card is used for identity confirmation and identity authentication. For example, an employee opens a gate by bringing an employee ID card into contact with a card reader provided in a gate device, and enters an office or the like.

In recent years, biometric authentication using biometric information has started to spread (see PTL 1). PTL 1 describes that a series of processes including face authentication performed at the time of identity confirmation is performed in a short time. A face matching device of the literature performs face matching processing of matching the face image of the person to be authenticated or the imaged face data, which is the feature amount of the face image, with the face image registered in advance or the registered face data, which is the feature amount of the face image, and confirms whether the person to be authenticated is the person whose registered face data is registered.

### CITATION LIST

### Patent Literature

[PTL 1] JP 2018-109935 A

### SUMMARY OF INVENTION

### Technical Problem

As described above, the authentication using the employee ID card is performed by biometric authentication using biometric information. Here, each of the authentication with the employee ID card and the biometric authentication has advantages and disadvantages. For example, in the authentication using the employee ID card, the user needs to take out the employee ID card each time the authentication is performed. In addition, in the biometric authentication, there is a possibility that the authentication fails depending on an environmental situation or the like at the time of authentication.

It is a main object of the present invention to provide an authentication system, an authentication terminal, a method for controlling an authentication terminal, and a storage medium that contribute to enabling more convenient personal authentication.

### Solution to Problem

According to a first aspect of the present invention, there is provided an authentication system including: a terminal held by a user; an authentication server that stores first biometric information for performing biometric authentication of the user and first terminal authentication information for performing terminal authentication by the terminal; and an authentication terminal supporting the biometric authentication and the terminal authentication.

According to a second aspect of the present invention, there is provided an authentication terminal including: a biometric information acquisition unit configured to acquire biometric information of a user; a terminal access unit configured to access a terminal held by the user and acquire terminal authentication information for performing authentication by the terminal; and an authentication request unit configured to transmit an authentication request including the biometric information to an authentication server in a case where the biometric information is acquired, and transmit the authentication request including the terminal authentication information to the authentication server in a case where the terminal authentication information is acquired.

According to a third aspect of the present invention, there is provided a method for controlling an authentication terminal, the method including: in the authentication terminal, acquiring biometric information of a user; acquiring terminal authentication information for accessing a terminal held by the user and performing authentication by the terminal; and transmitting an authentication request including the biometric information to an authentication server when the biometric information is acquired, and transmitting the authentication request including the terminal authentication information to the authentication server when the terminal authentication information is acquired.

According to a fourth aspect of the present invention, there is provided a computer-readable storage medium storing a program for causing a computer mounted on an authentication terminal to execute: a process of acquiring biometric information of a user; a process of accessing a terminal held by the user and acquiring terminal authentication information for performing authentication by the terminal; and a process of transmitting an authentication request including the biometric information to an authentication server in a case where the biometric information is acquired, and transmitting the authentication request including the terminal authentication information to the authentication server in a case where the terminal authentication information is acquired.

### Advantageous Effects of Invention

According to each aspect of the present invention, there are provided an authentication system, an authentication terminal, a method for controlling an authentication terminal, and a storage medium that contribute to enabling more convenient personal authentication. Note that the effect of the present invention is not limited to the above. According to the present invention, other effects may be exhibited instead of or in addition to the effects.

### BRIEF DESCRIPTION OF DRAWINGS

FIG. 1 is a diagram for describing an outline of an example embodiment.

FIG. 2 is a diagram illustrating an example of a schematic configuration of an authentication system according to a first example embodiment.

FIG. 3 is a diagram for explaining an outline of an operation of the authentication system according to the first example embodiment.

FIG. 4 is a diagram illustrating an example of an authentication terminal ID list according to the first example embodiment.

FIG. 5 is a diagram illustrating an example of a processing configuration of the authentication terminal according to the first example embodiment.

FIG. 6 is a diagram for explaining the operation of the authentication control unit according to the first example embodiment.

FIG. 7 is a diagram illustrating an example of an authentication request according to the first example embodiment.

FIG. 8 is a diagram for explaining the operation of the authentication control unit according to the first example embodiment.

FIG. 9 is a diagram illustrating an example of a registration request according to the first example embodiment.

FIG. 10 is a diagram illustrating an example of a processing configuration of the authentication server according to the first example embodiment.

FIG. 11 is a diagram for explaining the operation of user registration according to the first example embodiment.

FIG. 12 is a diagram illustrating an example of a user information database according to the first example embodiment.

FIG. 13 is a diagram illustrating an example of a behavior history database according to the first example embodiment.

FIG. 14 is a diagram illustrating an example of a processing configuration of a terminal according to the first example embodiment.

FIG. 15 is a diagram for explaining the operation of the browsing request unit according to the first example embodiment.

FIG. 16 is a diagram for explaining the operation of the output unit according to the first example embodiment.

FIG. 17 is a sequence diagram illustrating an example of an operation of the authentication system according to the first example embodiment.

FIG. 18 is a diagram for explaining the operation of the authentication control unit according to a second example embodiment.

FIG. 19 is a diagram illustrating an example of a processing configuration of an authentication server 10 according to the third example embodiment.

FIG. 20 is a diagram for explaining an operation of a behavior history analysis unit according to the third example embodiment.

FIG. 21 is a diagram illustrating an example of a hardware configuration of an authentication terminal.

FIG. 22 is a diagram for describing an operation of an authentication control unit according to a modification of the disclosure of the present application.

FIG. 23 is a diagram for explaining an operation of an output unit according to a modification of the disclosure of the present application.

### EXAMPLE EMBODIMENT

First, an outline of an example embodiment will be described. Note that the reference numerals in the drawings attached to this outline are attached to each element for convenience as an example for assisting understanding, and the description of this outline is not intended to be any limitation. In addition, in a case where there is no particular explanation, the block described in each drawing represents not a configuration of a hardware unit but a configuration of a functional unit. Connection lines between blocks in each drawing include both bidirectional and unidirectional lines. The unidirectional arrow schematically indicates a flow of a main signal (data), and does not exclude bidirectionality. Note that, in the present specification and the drawings, elements that can be similarly described are denoted by the same reference numerals, and redundant description can be omitted.

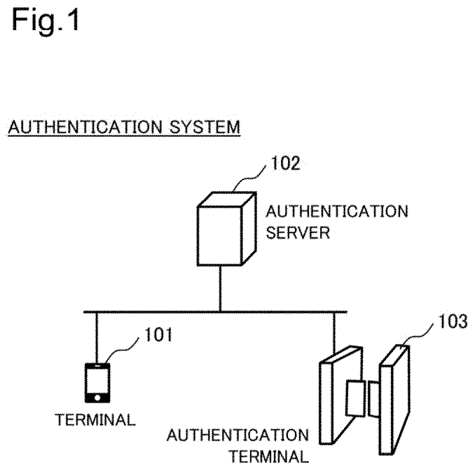

The authentication system according to the example embodiment includes a terminal 101 held by a user, an authentication server 102, and an authentication terminal 103 (see FIG. 1). The authentication server 102 stores first biometric information for performing biometric authentication of the user and first terminal authentication information for performing terminal authentication by the terminal 101. The authentication terminal 103 supports biometric authentication and terminal authentication.

The authentication terminal 103 included in the authentication system supports both authentication by the terminal 101 and authentication by biometric information. For example, even when the authentication terminal 103 fails in the biometric authentication, the user can receive the authentication by the terminal 101. That is, the convenience of the user is improved.

Hereinafter, specific example embodiments will be described in more detail with reference to the drawings.

### First Example Embodiment

A first example embodiment will be described in more detail with reference to the drawings.

### [System Configuration]

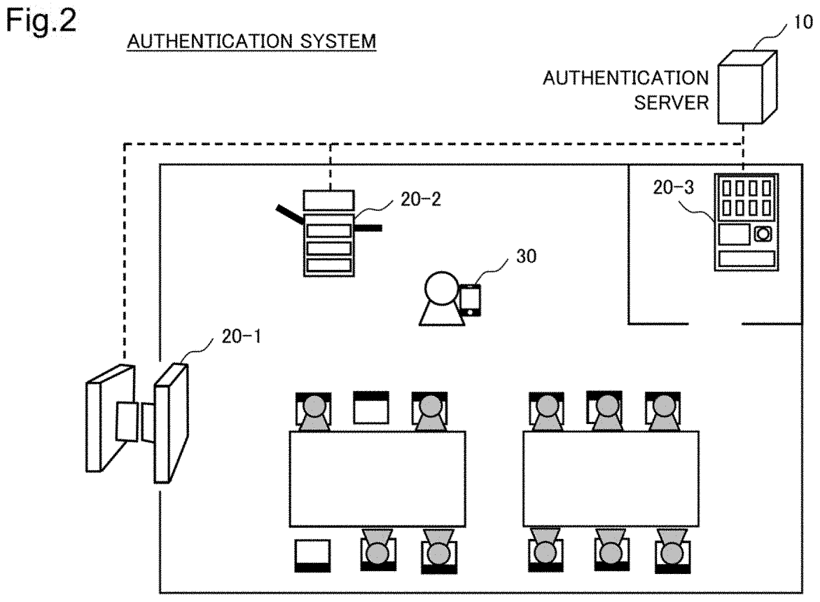

FIG. 2 is a diagram illustrating an example of a schematic configuration of the authentication system according to the first example embodiment. Referring to FIG. 2, the authentication system includes an authentication server 10, a plurality of authentication terminals 20-1 to 20-3, and a terminal 30 held by the user.

In the following description, when there is no particular reason to distinguish the authentication terminals 20-1 to 20-3, they are simply referred to as “authentication terminals 20”. Similarly, for other components, reference numerals on the left side separated by hyphens are used to represent the components.

The devices illustrated in FIG. 2 are connected to each other. For example, the authentication server 10 and the authentication terminal 20 are connected by wired or wireless communication means, and are configured to be able to communicate with each other.

Note that the authentication server 10 may be installed on the same floor or the same building as the authentication terminal 20, or may be installed on a network (on a cloud).

The authentication system illustrated in FIG. 2 enables authentication (personal authentication, personal authentication) associated with business execution in an office or the like. More specifically, the authentication system supports authentication using the biometric information of the user (biometric authentication) and authentication using the terminal 30 held by the user (hereinafter, referred to as terminal authentication).

The authentication server 10 is a device that enables the above two authentications. The authentication server 10 stores biometric information (for example, a face image or a feature amount generated from the face image) for enabling the biometric authentication. Further, the authentication server stores information (hereinafter, referred to as terminal authentication information; for example, a user ID to be described later) for enabling terminal authentication.

The biometric information is a face image, a fingerprint image, an iris image, a finger vein image, a palm print image, a palm vein image, or the like. The biometric information may be one or a plurality of pieces of biometric information. Note that the term “biometric information” in the disclosure of the present application means an image including all or a part of a living body and a feature amount extracted from the image.

The authentication terminal 20 is a device that provides a predetermined service or the like to an authenticated user (person who succeeded in authentication). The authentication terminal 20 is a terminal (hybrid terminal) supporting both biometric authentication and terminal authentication.

The authentication terminal 20-1 is a gate device and is installed at an entrance such as a building or a floor. The authentication terminal 20-1 permits passage of a person who succeeded in authentication.

The authentication terminal 20-2 is a copier. The authentication terminal 20-2 permits the person who succeeded in authentication to copy a document or the like.

The authentication terminal 20-3 is a vending machine. The authentication terminal 20-3 specifies a product purchaser (user) by authentication, and sells a product to the specified user.

The user (an employee or the like who uses the authentication system) holds the terminal 30 instead of the employee ID card. The terminal 30 incorporates an integrated circuit (IC) chip supporting near field communication (NFC). Information (user ID) of the same type as the terminal authentication information stored in the authentication server 10 is stored in the NFC chip. The terminal 30 functions as a “digital employee ID card” in place of the existing employee ID card.

Note that the configuration of the authentication system illustrated in FIG. 2 is an example and is not intended to limit the configuration of the system. For example, although three authentication terminals 20 are illustrated in FIG. 2, it is not intended to limit the number of authentication terminals 20. In addition, the function of each authentication terminal 20 is an example, and an authentication terminal 20 having another function may be included in the system. For example, the system may include an authentication terminal 20 that controls entrance and exit of a conference room. Alternatively, a plurality of authentication terminals 20 having the same type of function may be included in the system. For example, a plurality of copiers supporting both biometric authentication and terminal authentication may be included in the system.

### [Outline of System Operation]

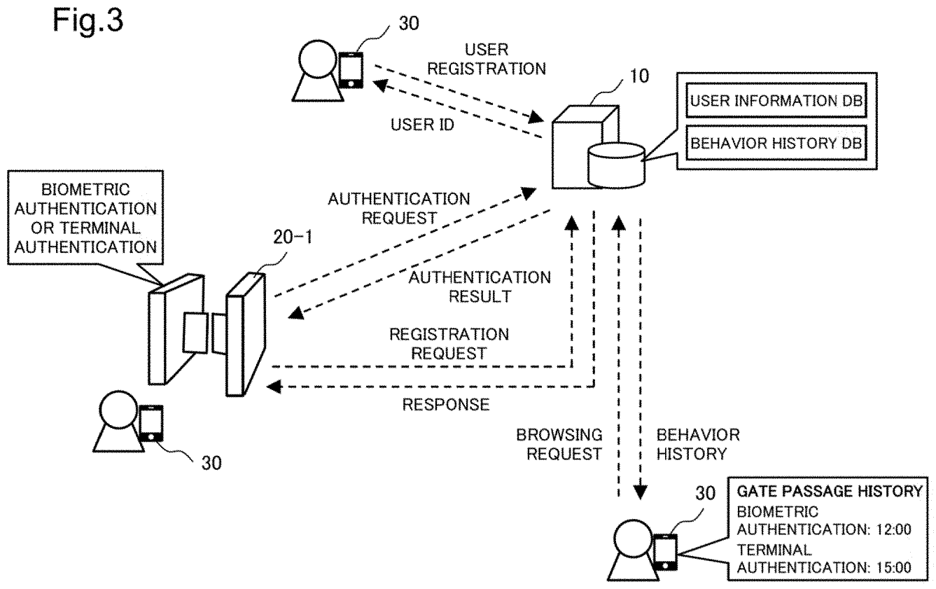

Next, an outline of an operation of the authentication system will be described with reference to FIG. 3.

The user performs system user registration prior to use of the authentication system. Specifically, the user operates the holding terminal 30 to register his/her face image, name, employee number, and the like in the authentication server 10.

When acquiring the information, the authentication server 10 generates a user identifier (ID) that uniquely identifies the user. The authentication server 10 associates the generated user ID, the biometric information of the user (the feature amount generated from the face image), and the personal information (name, employee number, and the like) with the user information database (DB; Data Base).

The authentication server 10 delivers the generated user ID to the user (terminal 30). The terminal 30 stores the acquired user ID in the internal NFC chip. Note that the authentication server 10 distributes an “authentication terminal ID list” to be described later to the terminal 30 at the time of user registration.

When the user registration is completed, the user is permitted to pass through the gate and use each device. The user moves in front of the authentication terminal 20. The authentication terminal 20 acquires a face image of the user and generates a feature amount from the face image. The authentication terminal 20 transmits an “authentication request” including the generated feature amount to the authentication server 10.

The authentication server 10 executes matching processing (1-to-N matching; N is a positive integer, and the same applies hereinafter) using the acquired feature amount and the feature amount registered in the user information database. The authentication server 10 determines that “authentication has succeeded” when the feature amount substantially matching the acquired feature amount is registered. The authentication server 10 determines that “authentication has failed” when the feature amount substantially matching the acquired feature amount is not registered.

The authentication server 10 transmits an authentication result (authentication success, authentication failure) to the authentication terminal 20. When the successful authentication is transmitted, the authentication server 10 transmits a response (authentication result) including the user ID of the person who succeeded in authentication to the authentication terminal 20.

The authentication terminal 20 performs an operation according to the authentication result. For example, when the authentication of the user is successful, the authentication terminal 20-1 opens the gate to allow the passage of the user.

The user can also receive terminal authentication using the terminal 30. The user brings the terminal 30 into contact with (or close to) a card reader provided in the authentication terminal 20. The authentication terminal 20 reads terminal authentication information (user ID) from the NFC chip built in the terminal 30 via the card reader. The authentication terminal 20 transmits an “authentication request” including the read user ID to the authentication server 10.

If the acquired user ID is registered in the user information database, the authentication server 10 determines that “authentication has succeeded”. If the acquired user ID is not registered in the database, the authentication server 10 determines that “authentication has failed”.

The authentication server 10 transmits an authentication result (authentication success, authentication failure) to the authentication terminal 20. Similarly to the biometric authentication, the authentication terminal 20 performs an operation according to the authentication result.

The authentication terminal 20 requests the authentication server 10 to register detailed information (hereinafter, referred to as detailed behavior information) on the behavior of the user (person who succeeded in authentication) in the subject device. Specifically, the authentication terminal 20 transmits, to the authentication server 10, a “registration request” including the detailed behavior information, the identification information (authentication terminal ID) assigned to the subject device, and the user ID of the person who succeeded in authentication.

The detailed behavior information includes an authentication date and time and an authentication method (biometric authentication, terminal authentication). Examples of the detailed behavior information specialized for each authentication terminal 20 include the number and format (color, monochrome) of documents duplicated by the copier (authentication terminal 20-2). The detailed behavior information generated by the vending machine (authentication terminal 20-3) includes the name of the purchased product, the amount of money, the number of products, and the like.

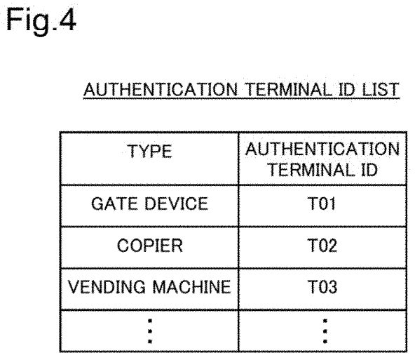

The authentication terminal ID is identification information shared by each device (authentication server 10, authentication terminal 20, terminal 30) included in the authentication system. The authentication terminal ID is identification information determined according to the type (gate device, copier, vending machine, and the like) of the authentication terminal 20. For example, a system administrator or the like determines an authentication terminal ID and generates an “authentication terminal ID list” (see FIG. 4). The system administrator or the like inputs the authentication terminal ID list to the authentication server 10, and sets an authentication terminal ID associated to each authentication terminal 20. As described above, the authentication terminal ID list is distributed to the terminal 30 at the time of user registration.

The authentication server 10 that has received the registration request (request including authentication terminal ID, user ID, and detailed behavior information) stores the information included in the registration request in the behavior history database in association with each other. When the information is stored in the database, the authentication server 10 transmits a positive response to the authentication terminal 20. When the registration in the database fails, the authentication server 10 transmits a negative response to the authentication terminal 20.

The user can browse a behavior history (information including at least one piece of detailed behavior information) in the authentication terminal 20 by operating the terminal 30. Specifically, the terminal 30 transmits, to the authentication server 10, a “browsing request” including the user ID and the authentication terminal ID of the authentication terminal 20 that desires to browse the behavior history.

The authentication server 10 searches the behavior history database using the user ID and the authentication terminal ID included in the browsing request as keys, and specifies the relevant behavior history. The authentication server 10 transmits the specified behavior history to the terminal 30.

Next, details of each device included in the authentication system according to the first example embodiment will be described.

### [Authentication Terminal]

The authentication terminal 20 is a hybrid terminal supporting biometric authentication and terminal authentication.

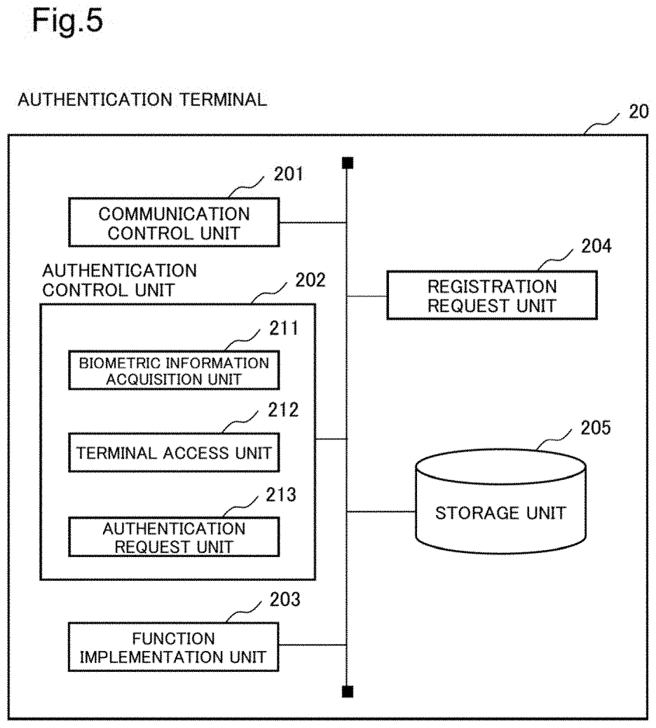

FIG. 5 is a diagram illustrating an example of a processing configuration (processing module) of the authentication terminal 20 according to the first example embodiment. Referring to FIG. 5, the authentication terminal 20 includes a communication control unit 201, an authentication control unit 202, a function implementation unit 203, a registration request unit 204, and a storage unit 205.

The communication control unit 201 is a unit that controls communication with other devices. For example, the communication control unit 201 receives data (packets) from the authentication server 10. In addition, the communication control unit 201 transmits data to the authentication server 10. The communication control unit 201 delivers data received from another device to another processing module. The communication control unit 201 transmits data acquired from another processing module to another device. In this manner, the other processing modules transmit and receive data to and from other devices via the communication control unit 201.

The authentication control unit 202 is a unit that performs control related to authentication of the user. The authentication control unit 202 determines whether to request the authentication server 10 to perform biometric authentication or terminal authentication. Various methods and schemes can be considered for the determination by the authentication control unit 202.

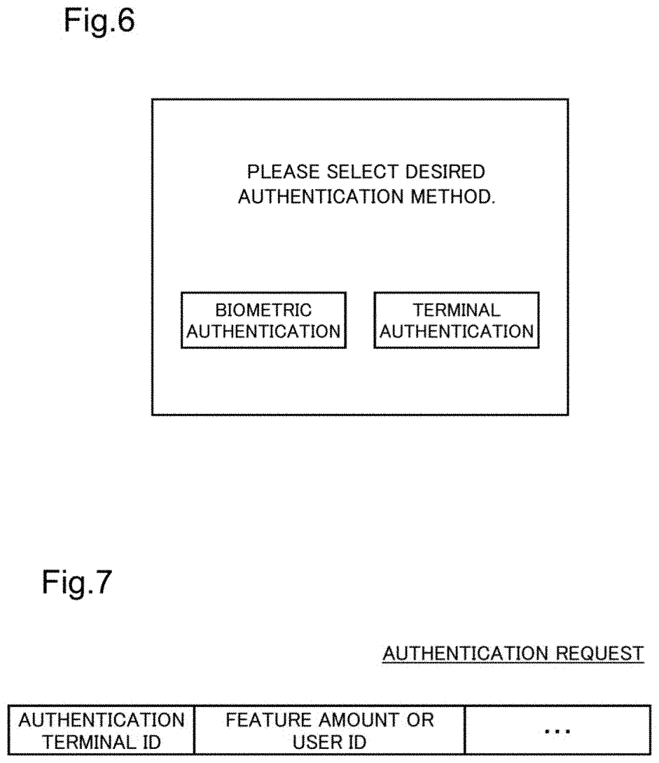

For example, when detecting the user in front using a motion sensor or the like, the authentication control unit 202 acquires a desire of the user regarding use of either the biometric authentication or the terminal authentication. For example, the authentication control unit 202 generates a graphical user interface (GUI) as illustrated in FIG. 6 and acquires the desire of the user.

As illustrated in FIG. 5, the authentication control unit 202 includes a submodule including a biometric information acquisition unit 211, a terminal access unit 212, and an authentication request unit 213.

In a case where the user desires the biometric authentication, the authentication control unit 202 activates the biometric information acquisition unit 211 to acquire the face image of the user.

The biometric information acquisition unit 211 controls the camera device (the camera device included in the authentication terminal 20) to acquire the face image of the user. Specifically, the biometric information acquisition unit 211 extracts a face image from the image data. Note that, since an existing technology can be used for the face image detection processing and the face image extraction processing by the biometric information acquisition unit 211, detailed description thereof will be omitted. For example, the biometric information acquisition unit 211 may extract a face image (face area) from the image data using a learning model learned by a convolutional neural network (CNN). Alternatively, the biometric information acquisition unit 211 may extract the face image using a method such as template matching.

The biometric information acquisition unit 211 generates a feature amount from the face image. The biometric information acquisition unit 211 generates a feature amount (a feature vector including a plurality of feature amounts) that characterizes the face image from the acquired face image. Specifically, the biometric information acquisition unit 211 extracts feature points from the acquired face image. Note that an existing technique can be used for the feature point extraction processing, and thus detailed description thereof will be omitted. For example, the biometric information acquisition unit 211 extracts eyes, a nose, a mouth, and the like as feature points from the face image. Thereafter, the biometric information acquisition unit 211 calculates the position of each feature point and the distance between the feature points as feature amounts, and generates a feature vector (vector information characterizing the face image) including a plurality of feature amounts.

The biometric information acquisition unit 211 delivers the generated feature amount to the authentication request unit 213.

When the user desires terminal authentication, the authentication control unit 202 activates the terminal access unit 212.

The terminal access unit 212 controls the card reader and reads terminal authentication information (user ID) from the NFC chip of the terminal 30. Terminal access unit 212 delivers the read user ID to authentication request unit 213.

The authentication request unit 213 is a unit that transmits an authentication request to the authentication server 10. Specifically, the authentication request unit 213 generates an authentication request including the feature amount generated from the face image or the user ID, and transmits the authentication request to the authentication server 10. Alternatively, the authentication request unit 213 may transmit an authentication request including the authentication terminal ID assigned to the subject device to the authentication server 10 (see FIG. 7).

The authentication control unit 202 receives an authentication result (authentication success, authentication failure) from the authentication server 10.

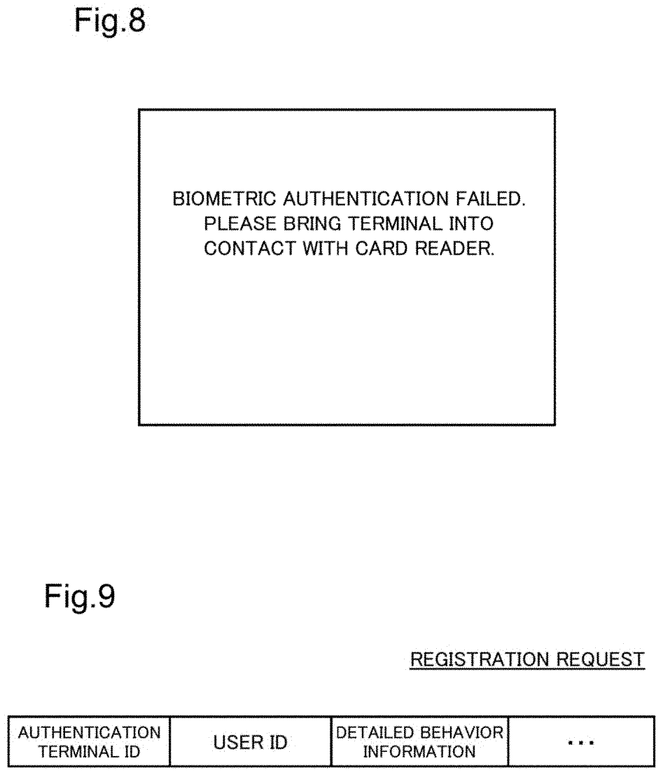

In a case where the authentication failure is received, the authentication control unit 202 notifies the user of the fact. For example, the authentication control unit 202 notifies the user that the authentication has failed using a liquid crystal panel, a speaker, or the like. Alternatively, the authentication control unit 202 may request the authentication server 10 to perform re-authentication by an authentication method that is not attempting authentication. For example, when the biometric authentication fails, the authentication control unit 202 may perform display as illustrated in FIG. 8 and transmit an authentication request including the acquired terminal authentication information (user ID) to the authentication server 10.

When the authentication success is received, the authentication control unit 202 notifies the function implementation unit 203 of the user ID, the authentication method (biometric authentication, terminal authentication), and the successful authentication included in the response from the authentication server 10.

The function implementation unit 203 is a unit that implements a function given to the authentication terminal 20. Details of the function implementation unit 203 are different depending on the function of each terminal and are different from the gist of the disclosure of the present application, and thus detailed description thereof is omitted.

For example, the function implementation unit 203 of the authentication terminal 20-1, which is a gate device, opens the gate when acquiring successful authentication. The function implementation unit 203 of the authentication terminal 20-2, which is a copier, permits the user to reproduce a document. The function implementation unit 203 of the authentication terminal 20-3, which is a vending machine, performs a product discharge process and a settlement process.

The function implementation unit 203 generates detailed behavior information (detailed information on the content of behavior of the user in the authentication terminal 20).

For example, the function implementation unit 203 of the authentication terminal 20-1 generates detailed behavior information including the time when the gate is opened and the authentication method (biometric authentication, terminal authentication). The function implementation unit 203 of the authentication terminal 20-2 generates detailed behavior information including an authentication method, the number of copies, time, a method (color, monochrome), and the like. The function implementation unit 203 of the authentication terminal 20-3 generates detailed behavior information including an authentication method, a purchased product name, a price, a purchase date and time, and the like.

The function implementation unit 203 delivers the generated detailed behavior information and the user ID of the person who succeeded in authentication to the registration request unit 204.

The registration request unit 204 is a unit that requests the authentication server 10 to register the detailed behavior information. The registration request unit 204 transmits a “registration request” including the authentication terminal ID, the user ID of the person who succeeded in authentication, and the detailed behavior information to the authentication server 10 (see FIG. 9).

In a case where an affirmative response is received from the authentication server 10, the registration request unit 204 does not perform a special operation. In a case where a negative response is received from the authentication server 10, the registration request unit 204 performs retransmission processing or the like of the The storage unit 205 is a unit that stores information necessary for the operation of the authentication terminal 20.

### [Authentication Server]

The authentication server 10 stores biometric information (first biometric information) for performing biometric authentication of the user and terminal authentication information (first terminal authentication information) for performing terminal authentication by the terminal 30. The authentication server 10 authenticates the user using the biometric information or the terminal authentication information.

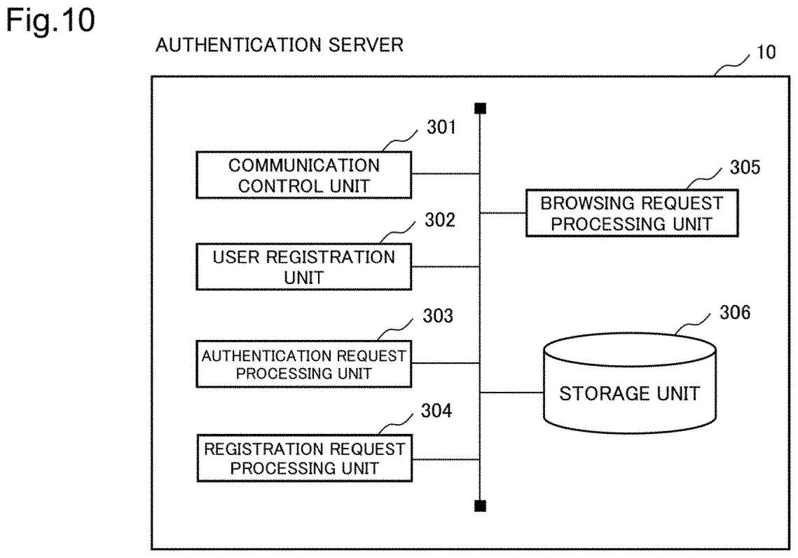

FIG. 10 is a diagram illustrating an example of a processing configuration (processing module) of the authentication server 10 according to the first example embodiment. Referring to FIG. 10, the authentication server 10 includes a communication control unit 301, a user registration unit 302, an authentication request processing unit 303, a registration request processing unit 304, a browsing request processing unit 305, and a storage unit 306.

The communication control unit 301 is a unit that controls communication with other devices. For example, the communication control unit 301 receives data (packets) from the authentication terminal 20. In addition, the communication control unit 301 transmits data to the authentication terminal 20. The communication control unit 301 delivers data received from another device to another processing module. The communication control unit 301 transmits data acquired from another processing module to another device. In this manner, the other processing modules transmit and receive data to and from other devices via the communication control unit 301.

The user registration unit 302 is a unit that registers a system user. The user registration unit 302 acquires a face image (biometric information) and personal information (name, employee number, and the like) of the user. The user registration unit 302 acquires a face image and personal information using any unit.

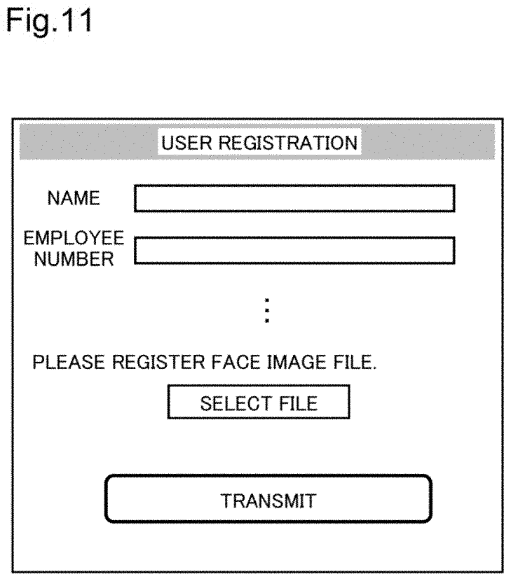

For example, when the terminal 30 accesses the authentication server 10, the user registration unit 302 displays a GUI as illustrated in FIG. 11 on the terminal 30.

The user inputs the information illustrated in FIG. 11. After inputting all the information, the user presses the “transmit” button, and inputs the face image and the personal information to the authentication server 10.

When acquiring the face image and the personal information, the user registration unit 302 generates a user ID to be assigned to the system user. For example, the user registration unit 302 may calculate a hash value of the acquired user information (face image, personal information) and assign the hash value to the user as the user ID. Alternatively, the user registration unit 302 may assign a unique value each time user registration is performed, and use the assigned value as the user ID.

The user registration unit 302 generates a feature amount that characterizes the face image from the acquired face image.

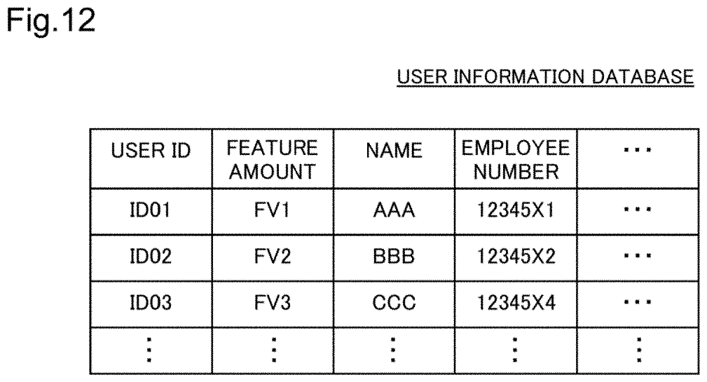

The user registration unit 302 stores the generated user ID, feature amount, and personal information in the user information database. The user registration unit 302 adds a new entry to the user information database in association with the information (user ID, feature amount, and personal information) (see FIG. 12).

The user registration unit 302 delivers the generated user ID to the terminal 30. At that time, the user registration unit 302 transmits an “authentication terminal ID list” to the terminal 30.

In this manner, the user registration unit 302 generates the user ID of the user in response to acquisition of the biometric information from the user, and stores the generated user ID as the terminal authentication information. The user registration unit 302 transmits the generated user ID to the terminal 30. The transmitted user ID is stored in the terminal 30 as terminal authentication information (second terminal authentication information).

The authentication request processing unit 303 is a unit that processes the authentication request received from the authentication terminal 20. The authentication request processing unit 303 acquires an authentication request from the authentication terminal 20. The authentication request processing unit 303 extracts a feature amount (biometric information) or a user ID (terminal authentication information) from the authentication request.

When the feature amount is extracted, the authentication request processing unit 303 sets the feature amount as the matching target and performs the matching processing with the feature amount registered in the user information database. More specifically, the authentication request processing unit 303 sets the feature amount (feature vector) as a matching target, and executes 1-to-N matching with a plurality of feature vectors registered in the user information database.

The authentication request processing unit 303 calculates similarity between the feature amount of the matching target and each of the plurality of feature amounts on the registration side. A chi-square distance, a Euclidean distance, or the like can be used as the similarity. Note that the farther the distance, the lower the similarity, and the closer the distance, the higher the similarity.

The authentication request processing unit 303 determines whether there is a feature amount whose similarity with the feature amount of the matching target is a predetermined value or more among the plurality of feature amounts registered in the user information database. When such a feature amount exists, the authentication request processing unit 303 sets the result of the authentication processing to “authentication success”. When such a feature amount does not exist, the authentication request processing unit 303 sets the result of the authentication process to “authentication failure”.

In a case where the user ID is acquired from the authentication request, the authentication request processing unit 303 searches the user information database using the acquired user ID as a key, and determines the presence or absence of an entry with a matching user ID. If the entry exists, the authentication request processing unit 303 sets the result of the authentication process to “authentication succeeded”. When such an entry does not exist, the authentication request processing unit 303 sets the result of the authentication process to “authentication failure”.

The authentication request processing unit 303 transmits an authentication result (authentication success, authentication failure) to the authentication terminal 20 which is a transmission source of the authentication request. When the authentication is successful, the authentication request processing unit 303 transmits a response including the user ID of the person who succeeded in authentication to the authentication terminal 20. Note that the authentication request processing unit 303 may transmit not only the authentication result but also the personal information (name and the like) of the person who succeeded in authentication to the authentication terminal 20 as the transmission source.

The registration request processing unit 304 is a unit that processes the registration request received from the authentication terminal 20. The registration request processing unit 304 receives the registration request from authentication terminal 20. The registration request processing unit 304 extracts the user ID from the registration request.

The registration request processing unit 304 searches the behavior history database using the extracted user ID as a key, and adds a new entry if there is no relevant entry.

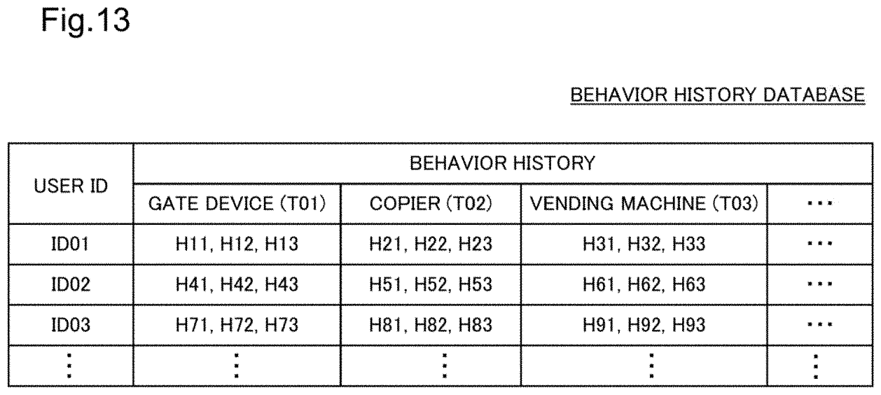

FIG. 13 is a diagram illustrating an example of the behavior history database. As illustrated in FIG. 13, the behavior history database stores a behavior history (at least one or more pieces of detailed behavior information) for each authentication terminal 20 (for each authentication terminal ID) for each user (user ID). For example, for the user with the user ID “ID01”, detailed behavior information H11, H12, and H13 is stored as the behavior history in the gate device (authentication terminal 20-1). Each of the detailed behavior information H11 to H13 includes information regarding a date and time when the vehicle has passed through the gate device and an authentication method (biometric authentication, terminal authentication).

The behavior history database is searched using the user ID extracted from the registration request as a key, and in a case where the relevant entry exists, the registration request processing unit 304 adds the detailed behavior information to the relevant behavior history field of the entry.

When the registration request from the authentication terminal 20 is normally processed, the registration request processing unit 304 transmits an affirmative response to the authentication terminal 20. In a case where the registration request from the authentication terminal 20 cannot be normally processed, the registration request processing unit 304 transmits a negative response to the authentication terminal 20.

The browsing request processing unit 305 is a unit that processes the browsing request received from the terminal 30. The browsing request processing unit 305 extracts the user ID and the authentication terminal ID from the browsing request received from the terminal 30.

The browsing request processing unit 305 searches the behavior history database using the extracted user ID and authentication terminal ID as keys, and specifies a relevant behavior history (at least one piece of detailed behavior information). The browsing request processing unit 305 transmits the specified behavior history to the terminal 30.

The storage unit 306 is a unit that stores information necessary for the operation of the authentication server 10.

### [Terminal]

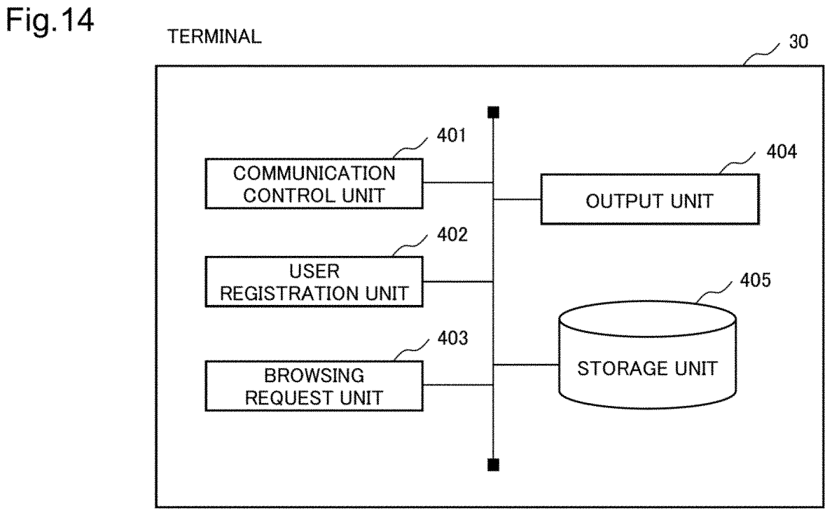

FIG. 14 is a diagram illustrating an example of a processing configuration (processing module) of the terminal 30 according to the first example embodiment. Referring to FIG. 14, the terminal 30 includes a communication control unit 401, a user registration unit 402, a browsing request unit 403, an output unit 404, and a storage unit 405.

The communication control unit 401 is a unit that controls communication with other devices. For example, the communication control unit 401 receives data (packets) from the authentication server 10. In addition, the communication control unit 401 transmits data to the authentication server 10. The communication control unit 401 delivers data received from another device to another processing module. The communication control unit 401 transmits data acquired from another processing module to another device. In this manner, the other processing modules transmit and receive data to and from other devices via the communication control unit 401.

The user registration unit 402 is a unit that enables user registration for using the authentication system. The user registration unit 402 operates as a pair with the user registration unit 302 of the authentication server 10. The user registration unit 402 acquires the information illustrated in FIG. 11 from the user and transmits the acquired information to the authentication server 10.

When the authentication server 10 ends the user registration, the user registration unit 402 acquires the user ID and the authentication terminal ID list from the authentication server 10. The user registration unit 402 stores the user ID and the authentication terminal ID list in the storage unit 405. Further, the user registration unit 402 stores the user ID in the NFC chip.

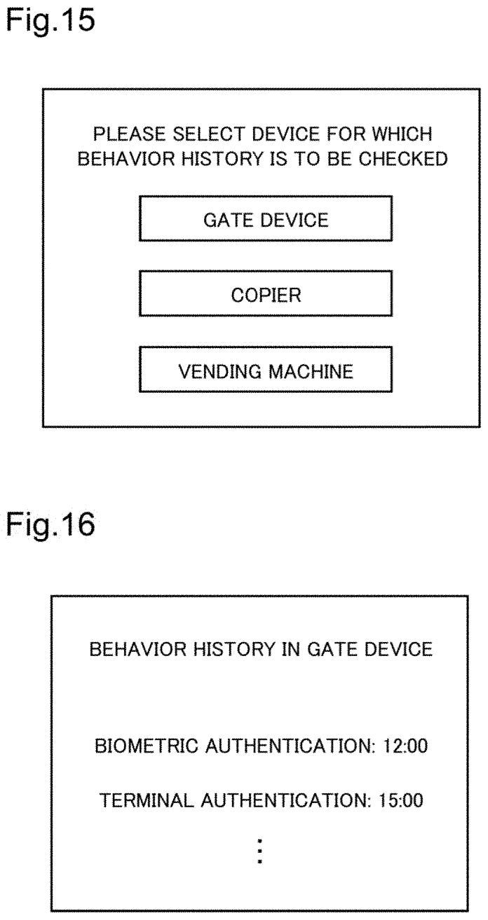

The browsing request unit 403 is a unit that transmits a browsing request to the authentication server 10. The browsing request unit 403 generates, for example, a GUI as illustrated in FIG. 15, and acquires information of the authentication terminal 20 of which the user wants to check the behavior history.

The browsing request unit 403 refers to the authentication terminal ID list and acquires the authentication terminal ID of the authentication terminal 20 of which the user wishes to browse the behavior history. The browsing request unit 403 transmits a browsing request including the user ID and the authentication terminal ID to the authentication server 10. The browsing request unit 403 delivers the behavior history acquired from the authentication server 10 to the output unit 404.

The output unit 404 is a unit that outputs various messages and the like to the outside. For example, the output unit 404 outputs the behavior history acquired from the browsing request unit 403 to a liquid crystal panel or the like (see FIG. 16).

The storage unit 405 is a unit that stores information necessary for the operation of the terminal 30.

### [Operation of System]

Next, an operation of an entrance management system according to the first example embodiment will be described.

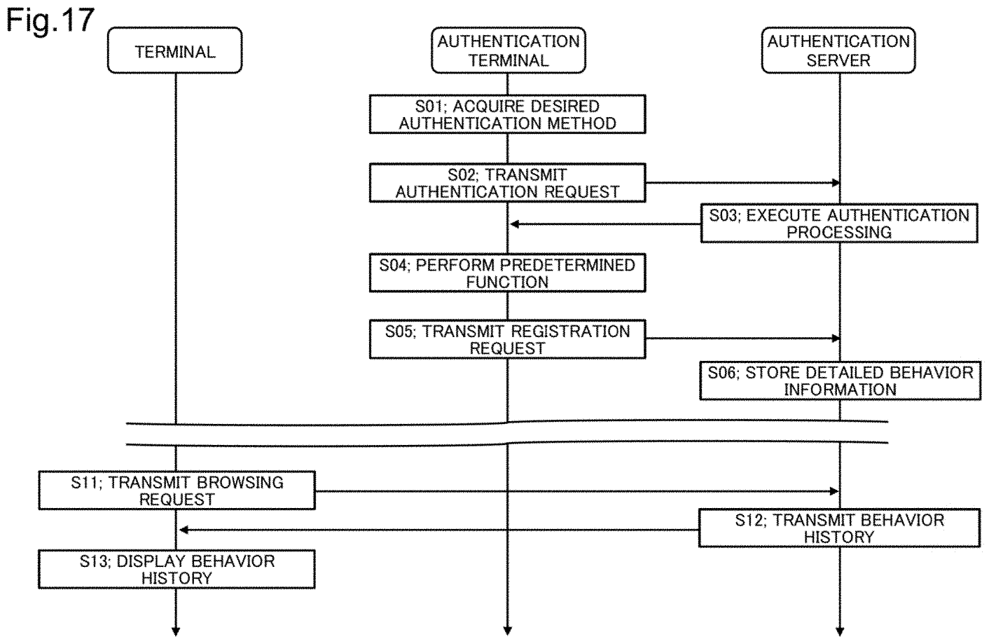

FIG. 17 is a sequence diagram illustrating an example of the operation of the authentication system according to the first example embodiment. It is assumed that the system user is registered in advance prior to the operation of FIG. 17.

When the user is located in front of the authentication terminal 20, the authentication terminal 20 acquires a desire of the user regarding the authentication method (step S01).

The authentication terminal 20 transmits an authentication request corresponding to the authentication method desired by the user to the authentication server 10 (step S02). In a case where the user desires the biometric authentication, the authentication terminal 20 transmits an authentication request including the biometric information (second biometric information) of the user to the authentication server 10. When the user desires terminal authentication, the authentication terminal 20 transmits an authentication request including terminal authentication information (second terminal authentication information) acquired from the terminal 30 to the authentication server 10.

The authentication server 10 executes authentication processing (matching processing) using the acquired biometric information or terminal authentication information (step S03). The authentication server 10 transmits the result of the authentication process (authentication success, authentication failure) to the authentication terminal 20.

When the authentication success is received, the authentication terminal 20 performs a predetermined function (for example, gate unlocking, copy permission, and the like) (step S04).

The authentication terminal 20 transmits a registration request including detailed behavior information obtained by performing the predetermined function to the authentication server 10 (step S05). More specifically, the authentication terminal 20 transmits, to the authentication server 10, a registration request including the authentication terminal ID assigned to the subject device and detailed information (detailed behavior information) on the behavior of the user in the subject device.

The authentication server 10 stores the detailed behavior information in the behavior history database (step S06). More specifically, the authentication server 10 stores the authentication terminal ID and the detailed behavior information in the behavior history database in association with each other.

According to the operation of the user, the terminal 30 transmits a browsing request including the authentication terminal ID to the authentication server 10 at any timing (step S11).

The authentication server 10 transmits at least one or more pieces of detailed behavior information associated to the authentication terminal ID included in the browsing request to the terminal 30 as a “behavior history” (step S12).

The terminal 30 displays the received behavior history (at least one piece of detailed behavior information) (step S13).

As described above, the authentication system according to the first example embodiment supports both authentication by the mobile terminal (terminal 30) and authentication by biometric information for use of various facilities or the like. As a result, the convenience of the user can be enhanced. For example, in the authentication of only the terminal 30, it is necessary to take out the terminal 30 every time the terminal passes through the gate. However, since the gate device supports biometric authentication, the user can pass through the gate simply by moving in front of the gate device. In the biometric authentication, there is a possibility that the authentication fails due to a change in environment or appearance when the face image is acquired. Even in such a case, if the user holds the terminal 30, the user can enter and exit only by holding the terminal 30 over the gate device.

The terminal 30 can also display information (detailed behavior information, behavior history) generated as a result of the authentication process. For example, when the user passes through the gate by biometric authentication, the user can know the fact of the passage. Alternatively, in a case where an article is purchased by biometric authentication, the user can confirm details of the article purchase (purchase item, purchase amount, purchase date and time, and the like) via the terminal 30.

### Second Example Embodiment

Next, a second example embodiment will be described in detail with reference to the drawings.

In the first example embodiment, it has been described that authentication is performed according to the authentication method selected by the user. In the second example embodiment, a case where the authentication terminal 20 automatically selects an authentication method will be described.

Since the configuration of the authentication system according to the second example embodiment can be the same as that of the first example embodiment, the description corresponding to FIG. 2 is omitted. In addition, since the processing configurations of the authentication server 10, the authentication terminal 20, and the terminal 30 according to the second example embodiment can also be the same as those of the first example embodiment, the description thereof will be omitted.

Hereinafter, differences between the first and second example embodiments will be mainly described.

The authentication control unit 202 of the authentication terminal 20 attempts to acquire the biometric information and the terminal authentication information in cooperation with the biometric information acquisition unit 211 and the terminal access unit 212. The authentication request unit 213 transmits, to the authentication server 10, an authentication request associated to either one of the biometric information and the terminal authentication information, whichever is acquired earlier. That is, when the face image of the user is photographed and the terminal authentication information (user ID) is successfully read from the terminal 30 before the feature amount is generated from the face image, the authentication request unit 213 transmits an authentication request by terminal authentication. In this manner, the authentication terminal 20 may request the authentication server 10 to perform authentication by an authentication method supporting either one of the biometric information and the terminal authentication information, whichever is acquired earlier.

The authentication control unit 202 may determine the authentication method according to the elapsed time from the detection of the user in front. For example, in a case where the terminal authentication information (user ID) can be acquired from the terminal 30 within a predetermined time (for example, 1 second) after the detection of the user in front, the authentication control unit 202 instructs the authentication request unit 213 to transmit an authentication request by terminal authentication. On the other hand, in a case where the terminal authentication information cannot be acquired even after the predetermined time has elapsed (in a case where the user does not bring the terminal 30 into contact with the card reader), the authentication control unit 202 instructs the authentication request unit 213 to transmit an authentication request by biometric authentication. As described above, when the authentication terminal 20 can acquire the terminal authentication information during the predetermined time after the user is detected, the authentication terminal 20 may request the authentication server 10 to perform authentication by terminal authentication.

The authentication control unit 202 may preferentially handle one of the two authentication methods. For example, the authentication control unit 202 instructs the authentication request unit 213 to transmit an authentication request by biometric authentication immediately after the biometric information acquisition unit 211 finishes generating the biometric information (feature amount). In addition, when recognizing that the terminal 30 has come in contact with the card reader via the terminal access unit 212 before the authentication result from the biometric authentication is obtained, the authentication control unit 202 transmits a cancellation notification of the previously transmitted authentication request (authentication request by the biometric authentication) to the authentication server 10. Thereafter, the authentication control unit 202 instructs the authentication request unit 213 to transmit an authentication request including the terminal authentication information acquired from the terminal 30. As described above, when the terminal authentication information is acquired before the authentication result from the biometric authentication is received from the authentication server 10, the authentication terminal 20 transmits a notification to cancel the authentication by the biometric authentication to the authentication server 10. Thereafter, the authentication terminal 20 requests the authentication server 10 to perform authentication using the acquired terminal authentication information.

The authentication terminal 20 may perform pre-verification (verification executed before transmission of the authentication request) on the acquired biometric information and terminal authentication information, and perform an operation according to the result. Specifically, the authentication terminal 20 may verify validity of the biometric information and the terminal authentication information, and determine an authentication method to be requested to the authentication server 10 according to a result of verification of the validity.

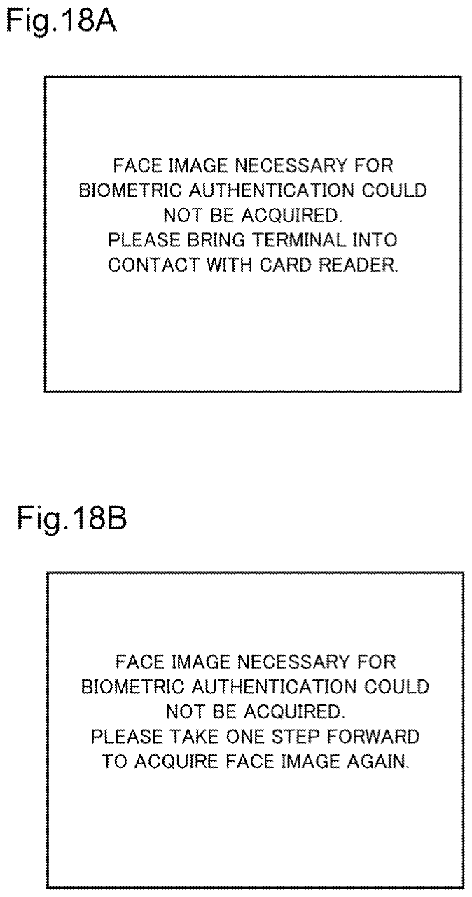

For example, the biometric information acquisition unit 211 confirms the quality of the face image before generating the feature amount. For example, the biometric information acquisition unit 211 calculates the size, luminance, and the like of the face area. In a case where these values are not included in the predetermined range, the authentication control unit 202 determines that the face image is not suitable for biometric authentication. In this case, the authentication control unit 202 does not select transmission of the authentication request based on the acquired biometric information. For example, as illustrated in FIG. 18(a), the authentication control unit 202 may perform display to bring the terminal 30 into contact with the card reader. Alternatively, as illustrated in FIG. 18(b), the authentication control unit 202 may perform display for correcting the standing position or the like of the user in such a way as to obtain an appropriate face image.

Alternatively, the authentication control unit 202 may verify validity of the terminal authentication information (user ID) acquired from the terminal 30. For example, in a case where the numerical range of the user ID for which authentication succeeds is determined in advance, if the acquired user ID is not included in the numerical range, the authentication control unit 202 does not select transmission of the authentication request based on the acquired terminal authentication information. Alternatively, when an error detection code (checksum) is assigned to the user ID stored in the terminal 30, the authentication control unit 202 may verify the validity of the terminal authentication information using the checksum. When the acquired terminal authentication information is not valid, the authentication control unit 202 may select the biometric authentication, or may perform a display to urge the terminal 30 to make contact again.

As described above, in the authentication system according to the second example embodiment, the feature amount is extracted from the face image captured by the authentication terminal 20, and the extracted feature amount is matched with the feature amount registered in the user information database to specify the user. In the authentication system according to the second example embodiment, the authentication terminal 20 automatically selects the authentication method. As a result, the convenience of the user can be further improved.

### Third Example Embodiment

Next, a third example embodiment will be described in detail with reference to the drawings.

In the third example embodiment, an authentication server 10 that makes it possible to easily grasp the usage status and the like of each authentication means in a case where two authentication means (biometric authentication, terminal authentication) are used in combination will be described.

Since the configuration of the authentication system according to the third example embodiment can be the same as that of the first example embodiment, the description corresponding to FIG. 2 is omitted. In addition, since the processing configurations of the authentication terminal 20 and the terminal 30 according to the third example embodiment can be the same as those of the first example embodiment, the description thereof will be omitted.

Hereinafter, differences between the first to third example embodiments will be mainly described.

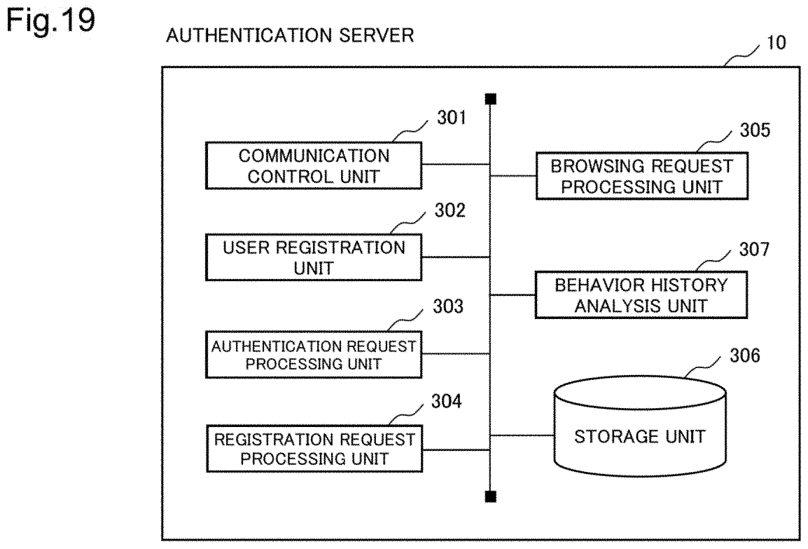

FIG. 19 is a diagram illustrating an example of a processing configuration (processing module) of the authentication server 10 according to the third example embodiment.

Referring to FIG. 19, the authentication server 10 according to the third example embodiment includes a behavior history analysis unit 307.

The behavior history analysis unit 307 is a unit that analyzes the behavior history of each user accumulated in the behavior history database. For example, the behavior history analysis unit 307 analyzes the authentication method performed by the authentication terminal 20 using the detailed behavior information stored in the behavior history database.

For example, the behavior history analysis unit 307 calculates an implementation ratio of biometric authentication to terminal authentication in a predetermined period (for example, 1 hour, 1 day, 1 month) for each authentication terminal 20. Specifically, the behavior history analysis unit 307 calculates the total number of authentications performed during a predetermined period (the total number of pieces of detailed behavior information). The behavior history analysis unit 307 calculates an implementation ratio (use ratio) of each authentication means by dividing the number of biometric authentications performed in each authentication terminal 20 and the number of terminal authentications by the total number.

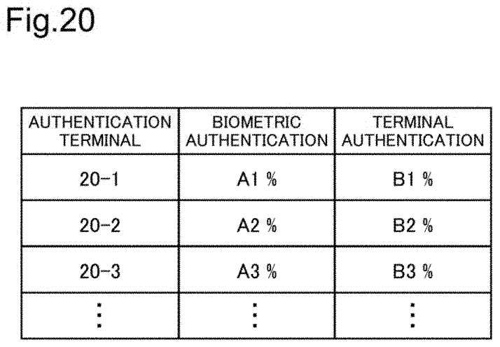

For example, the behavior history analysis unit 307 outputs an analysis result (implementation ratio for each authentication means in each authentication terminal) as illustrated in FIG. 20. An administrator or the like who has received the analysis result as illustrated in FIG. 20 investigates the cause of the usage rate that varies for each authentication terminal 20, and considers improvement, expansion, or the like of the authentication terminal 20 as necessary. Alternatively, the behavior history analysis unit 307 may propose a layout change of the authentication terminal 20, a change in the number of authentication terminals 20, or the like on the basis of the analysis result.

Note that the calculation of the implementation rate for each authentication method by the behavior history analysis unit 307 is an example and is not intended to limit the analysis target or the like of the behavior history analysis unit 307. For example, the authentication server 10 stores details of the authentication process (authentication method, authentication result) for each authentication terminal 20. The behavior history analysis unit 307 may calculate the “authentication failure rate” for each authentication terminal 20 from the accumulated details of the authentication process.

Alternatively, the behavior history analysis unit 307 may display the number of executions (the number of authentication successes) of each authentication means in a predetermined period instead of the usage rate of each authentication means as illustrated in FIG. 20. At that time, the behavior history analysis unit 307 may display the total number of authentications (the total value of biometric authentication and terminal authentication) in a predetermined period.

In addition, the analysis result by the behavior history analysis unit 307 can be used for various purposes. For example, the behavior history analysis unit 307 may transmit a notification prompting a user (employee or the like) having a low usage rate of the biometric authentication to more actively use the biometric authentication.

As described above, the authentication server 10 according to the third example embodiment analyzes the behavior history accumulated for each user and provides useful information for the system administrator or the like.

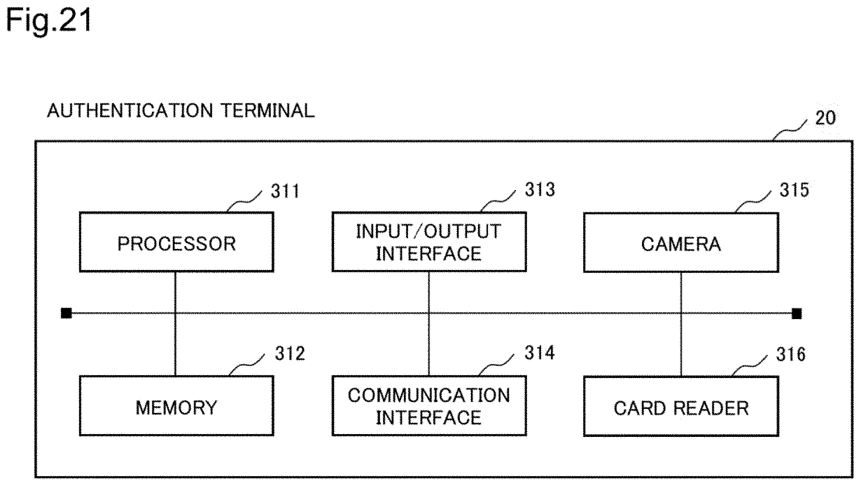

Next, hardware of each device constituting the authentication system will be described. FIG. 21 is a diagram illustrating an example of a hardware configuration of the authentication terminal 20.

The authentication terminal 20 has the configuration illustrated in FIG. 21. For example, the authentication terminal 20 includes a processor 311, a memory 312, an input/output interface 313, a communication interface 314, a camera 315, a card reader 316, and the like. The components such as the processor 311 are connected by an internal bus or the like and are configured to be able to communicate with each other.

However, the configuration illustrated in FIG. 21 is not intended to limit the hardware configuration of the authentication terminal 20. The authentication terminal may include hardware (not illustrated) or may not include the input/output interface 313 as necessary. In addition, the number of processors 311 and the like included in the authentication terminal 20 is not limited to the example of FIG. 21, and for example, a plurality of processors 311 may be included in the authentication terminal 20.

The processor 311 is a programmable device such as a central processing unit (CPU), a micro processing unit (MPU), or a digital signal processor (DSP).

Alternatively, the processor 311 may be a device such as a field programmable gate array (FPGA) or an application specific integrated circuit (ASIC). The processor 311 is configured to execute various programs including an operating system (OS; Operating System).

The memory 312 is a random access memory (RAM), a read only memory (ROM), a hard disk drive (HDD), a solid state drive (SSD), or the like. The memory 312 stores an OS program, an application program, and various types of data.

The input/output interface 313 is an interface of a display device or an input device (not illustrated). The display device is, for example, a liquid crystal display or the like. The input device is, for example, a device that receives a user operation such as a keyboard or a mouse.

The communication interface 314 is a circuit, a module, or the like that communicates with another device. For example, the communication interface 314 includes a network interface card (NIC) or the like.

The camera 315 acquires biometric information (face image) of the user, and the card reader 316 accesses the NFC chip of the terminal 30.

The function of the authentication terminal 20 is enabled by various processing modules. The processing module is implemented, for example, by the processor 311 executing a program stored in the memory 312. Furthermore, the program can be recorded in a computer-readable storage medium. The storage medium may be a non-transient (non-transitory) medium such as a semiconductor memory, a hard disk, a magnetic recording medium, or an optical recording medium. That is, the present invention can also be embodied as a computer program product. Furthermore, the program can be downloaded via a network or updated using a storage medium storing the program. Further, the processing module may be implemented by a semiconductor chip.

Note that the authentication server 10, the terminal 30, and the like can also be configured similarly to the authentication terminal 20, and since there is no difference in the basic hardware configuration from the authentication terminal 20, the description thereof will be omitted. Note that the authentication server 10 and the terminal 30 do not need a camera or a card reader. The terminal 30 includes an NFC chip.

The authentication terminal 20 is equipped with a computer and can enable the function of the authentication terminal 20 by causing the computer to execute a program. In addition, the authentication terminal 20 executes the method for controlling the authentication terminal by the program.

### Modified Example

Note that the configuration, operation, and the like of the authentication system described in the above example embodiment are merely examples, and are not intended to limit the configuration and the like of the system.

In the above example embodiment, the authentication system has been described by taking identity confirmation in an office or the like in which a copier or the like is installed as an example, but the authentication system disclosed in the present application may be applied to identity confirmation in a factory or the like.

In the above example embodiment, the case where the user ID is used as the terminal authentication information has been described, but other information may be used as the terminal authentication information. For example, an employee number may be used as the terminal authentication information. That is, any information may be used as the terminal authentication information as long as the information can uniquely identify the user in the authentication system.

In the above example embodiment, the example in which the authentication terminal ID is determined according to the type of the authentication terminal 20 has been described, but the authentication terminal ID may be determined in such a way that each authentication terminal 20 included in the system can be identified. For example, each authentication terminal 20 may be distinguished by attaching a branch number to the authentication terminal ID described above. For example, when the system includes two gate devices, an authentication terminal ID such as “T01-1” and “T01-2” may be assigned to each gate device.

Alternatively, when the authentication terminal ID is determined in such a way that the authentication terminals 20 can be distinguished from each other, the terminal 30 may request the behavior history browsing for the individual authentication terminal 20, or may request the behavior history browsing for the same type of authentication terminal 20. In the above example, when “T01-1” is included in the browsing request as the authentication terminal ID, authentication server 10 returns the behavior history in the gate device associated to the ID to terminal 30. Alternatively, when “T01” is included in the browsing request as the authentication terminal ID, authentication server 10 returns the behavior history regarding the entire gate device (two gate devices) to terminal 30.

The browsing request transmitted by the terminal 30 may include information regarding the range of the behavior history desired to be browsed. For example, the terminal 30 may transmit a browsing request including the period, the number, and the like of the behavior history to be browsed to the authentication server 10. The authentication server 10 extracts a behavior history (at least one or more pieces of detailed behavior information) conforming to the range, and transmits the extracted behavior history to the terminal 30.

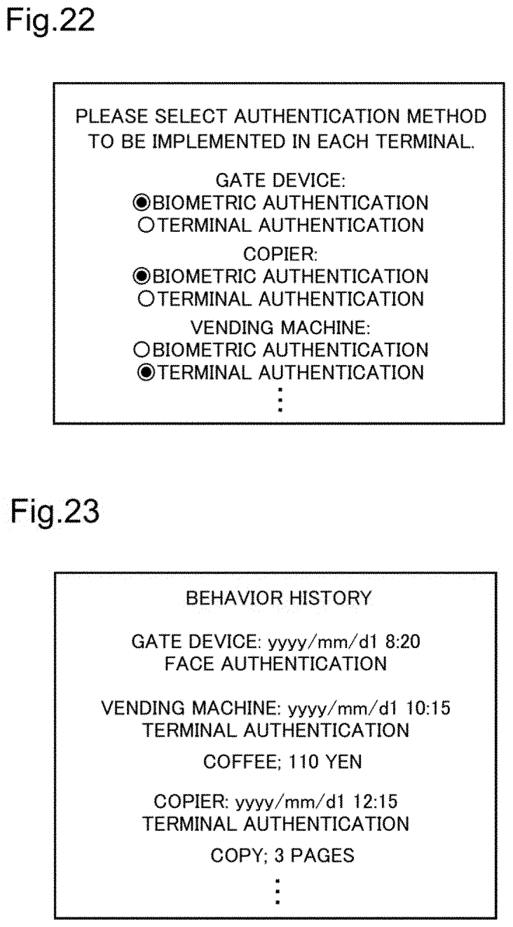

Alternatively, an authentication method (biometric authentication, terminal authentication) performed for each authentication terminal 20 may be registered in advance. For example, regarding authentication in the gate device (authentication terminal 20-1), biometric authentication is selected with emphasis on convenience. On the other hand, with respect to authentication (settlement processing) in the vending machine (authentication terminal 20-3), reliability is emphasized, and terminal authentication is selected. In the authentication system of the disclosure of the present application, in order to enable the preselection of the authentication method, a mechanism for acquiring the desire of the user is prepared. Specifically, the terminal 30 displays a GUI as illustrated in FIG. 22 and acquires an authentication method performed by each authentication terminal 20. The terminal 30 and the authentication terminal 20 communicate with each other using proximity wireless communication means such as Bluetooth (registered trademark). The authentication terminal 20 acquires an authentication method desired by the user from the terminal 30 located in the vicinity of the subject device, and selects authentication by the acquired authentication method.

Note that the acquired authentication method may be treated as a preferential authentication method in the two authentication methods.

In the above example embodiment, the case where the behavior history of each authentication terminal 20 is provided to the user (browsed by the user) has been described, but the behavior history covering each authentication terminal 20 may be provided to the user. For example, the terminal 30 adds an item “all terminals” to the display illustrated in FIG. 15. When receiving the browsing request including “all terminals”, the authentication server 10 transmits the behavior history across the plurality of authentication terminals 20 related to the user ID included in the browsing request to the terminal 30. In the example of FIG. 13, in a case where a browsing request including “ID01” as the user ID is received, the behavior histories (detailed behavior information) of H11 to H13, H21 to H23, and H31 to H33 are transmitted to the terminal 30. The terminal 30 displays the acquired behavior history. At that time, the terminal 30 displays the acquired detailed behavior information side by side in time series (see FIG. 23).

In the above example embodiment, it has been described that the authentication server 10 collects (stores) the behavior history of the user according to the registration request received from the authentication terminal 20. However, the authentication server 10 may store information obtained from a device, a device, or the like other than the authentication terminal 20 as a “behavior history”. For example, a camera device may be installed in an elevator hall or a dining room, and the authentication server 10 may accumulate the behavior history of the user by analyzing an image obtained from the camera device. In this case, the time when the user uses the elevator or the like is accumulated as the behavior history. Note that the authentication server 10 may specify the user (user ID) using an image obtained from the camera device.

In the above example embodiment, the case where the authentication server 10 stores the behavior history has been described, but the function may be performed by another server. Specifically, the system may include a server (database server) having a function of processing a registration request from the authentication terminal 20, a function of processing a browsing request from the terminal 30, and a function of managing a behavior history database. Alternatively, the authentication server 10 may not include the user information database as illustrated in FIG. 12, and a database server that manages the user information database may be included in the system.

In the above example embodiment, the case where the authentication request includes any one of the biometric information (feature amount) and the terminal authentication information (user ID) has been described, but the authentication terminal may include these pieces of information in one authentication request. Specifically, in a case where the two pieces of information can be acquired together in a predetermined period, the authentication terminal 20 may transmit an authentication request including the biometric information and the terminal authentication information to the authentication server 10. In this case, the authentication server may determine that “authentication has succeeded” when the authentication using either one of the pieces of information is successful, or may determine that “authentication has succeeded” when the authentication using the two pieces of information is successful.

The user information database and the behavior history database described in the above example embodiment are merely examples, and are not intended to limit the contents and the like stored in each database. For example, the user information database may store a face image instead of or in addition to the feature amount.

In the above example embodiment, the case where the biometric information related to “the feature amount generated from the face image” is transmitted from the authentication terminal 20 to the authentication server 10 has been described. However, the biometric information related to the “face image” may be transmitted from the authentication terminal 20 to the authentication server 10. In this case, the authentication server 10 may generate a feature amount from the acquired face image and execute authentication processing (matching processing).

A form of data transmission and reception between the devices (authentication server 10, authentication terminal 20, terminal 30) is not particularly limited, but data transmitted and received between the devices may be encrypted. It is desirable that biometric information is transmitted and received between these devices, and encrypted data is transmitted and received in order to appropriately protect the biometric information.

In the flow chart (flowchart and sequence diagram) used in the above description, a plurality of steps (processes) are described in order, but the execution order of the steps executed in the example embodiment is not limited to the described order. In the example embodiment, for example, the order of the illustrated steps can be changed within a range in which there is no problem in terms of content, such as executing each process in parallel.

The above example embodiments have been described in detail in order to facilitate understanding of the present disclosure, and it is not intended that all the configurations described above are necessary. In addition, in a case where a plurality of example embodiments has been described, each example embodiment may be used alone or in combination. For example, a part of the configuration of the example embodiment can be replaced with the configuration of another example embodiment, or the configuration of another example embodiment can be added to the configuration of the example embodiment. Furthermore, it is possible to add, delete, and replace other configurations for a part of the configuration of the example embodiment.

Although the industrial applicability of the present invention is apparent from the above description, the present invention can be suitably applied to personal authentication of companies and the like.

Some or all of the above example embodiments may be described as the following Supplementary Notes, but are not limited to the following.

### [Supplementary Note 1]

An authentication system including:
a terminal held by a user;
an authentication server that stores first biometric information for performing biometric authentication of the user and first terminal authentication information for performing terminal authentication by the terminal; and
an authentication terminal supporting the biometric authentication and the terminal authentication.

### [Supplementary Note 2]

The authentication system according to Supplementary Note 1, wherein the authentication terminal transmits an authentication request including second biometric information of the user to the authentication server.

### [Supplementary Note 3]

The authentication system according to Supplementary Note 1, wherein the authentication terminal transmits an authentication request including second terminal authentication information acquired from the terminal to the authentication server.

### [Supplementary Note 4]

The authentication system according to any one of Supplementary Notes 1 to 3, wherein the authentication terminal acquires a desire of the user regarding use of either the biometric authentication or the terminal authentication.

### [Supplementary Note 5]

The authentication system according to any one of Supplementary Notes 1 to 4, wherein
the authentication terminal transmits, to the authentication server, a registration request including an authentication terminal ID assigned to the authentication terminal and detailed information on a behavior of the user in the authentication terminal, and
the authentication server stores the authentication terminal ID and the detailed information in association with each other.

### [Supplementary Note 6]

The authentication system according to Supplementary Note 5, wherein
the terminal transmits a browsing request including the authentication terminal ID to the authentication server, and
the authentication server transmits the detailed information associated to the authentication terminal ID to the terminal.

### [Supplementary Note 7]

The authentication system according to any one of Supplementary Notes 1 to 6, wherein the authentication server generates a user ID of the user in response to acquisition of the first biometric information from the user, and stores the generated user ID as the first terminal authentication information.

### [Supplementary Note 8]

The authentication system according to Supplementary Note 7 referring to Supplementary Note 3, wherein
the authentication server transmits the generated user ID to the terminal, and
the terminal stores the user ID as the second terminal authentication information.

### [Supplementary Note 9]

The authentication system according to any one of Supplementary Notes 1 to 8, wherein the first biometric information is a face image or a feature amount generated from the face image.

### [Supplementary Note 10]

The authentication system according to Supplementary Note 3, wherein the terminal stores the second terminal authentication information in an integrated circuit (IC) chip supporting near field communication (NFC).

### [Supplementary Note 11]

The authentication system according to Supplementary Note 4, wherein the authentication terminal generates a graphical user interface (GUI) for acquiring the desire of the user regarding use of either the biometric authentication or the terminal authentication.

### [Supplementary Note 12]

The authentication system according to any one of Supplementary Notes 1 to 3, wherein the authentication terminal requests the authentication server to perform authentication by an authentication method supporting either one of the first biometric information and the first terminal authentication information, whichever is acquired earlier.

### [Supplementary Note 13]

The authentication system according to any one of Supplementary Notes 1 to 3, wherein the authentication terminal requests the authentication server to perform authentication by the terminal authentication in a case where the first terminal authentication information can be acquired within a predetermined time after the user is detected.

### [Supplementary Note 14]

The authentication system according to any one of Supplementary Notes 1 to 3, wherein, when the first terminal authentication information is acquired before an authentication result from the biometric authentication is received from the authentication server, the authentication terminal transmits a notification for canceling the authentication by the biometric authentication to the authentication server and requests the authentication server to perform authentication using the acquired first terminal authentication information.

### [Supplementary Note 15]

The authentication system according to any one of Supplementary Notes 1 to 3, wherein the authentication terminal verifies validity of the first biometric information and the first terminal authentication information and determines an authentication method to be requested to the authentication server according to a result of verification of the validity.

### [Supplementary Note 16]

The authentication system according to Supplementary Note 5 or 6, wherein the authentication server further includes an analysis unit configured to analyze an authentication method performed by the authentication terminal using the stored detailed information.

### [Supplementary Note 17]

The authentication system according to Supplementary Note 16, wherein the analysis unit calculates an implementation ratio of the biometric authentication to the terminal authentication in a predetermined period.

### [Supplementary Note 18]

An authentication terminal including:
a biometric information acquisition unit configured to acquire biometric information of a user;
a terminal access unit configured to access a terminal held by the user and acquire terminal authentication information for performing authentication by the terminal; and
an authentication request unit configured to transmit an authentication request including the biometric information to an authentication server in a case where the biometric information is acquired and transmit the authentication request including the terminal authentication information to the authentication server in a case where the terminal authentication information is acquired.

### [Supplementary Note 19]

A method for controlling an authentication terminal, the method including:
in the authentication terminal,
acquiring biometric information of a user;
acquiring terminal authentication information for accessing a terminal held by the user and performing authentication by the terminal; and
transmitting an authentication request including the biometric information to an authentication server when the biometric information is acquired and transmitting the authentication request including the terminal authentication information to the authentication server when the terminal authentication information is acquired.

### [Supplementary Note 20]

A computer-readable storage medium storing a program for causing a computer mounted on an authentication terminal to execute:
a process of acquiring biometric information of a user;
a process of accessing a terminal held by the user and acquiring terminal authentication information for performing authentication by the terminal; and
a process of transmitting an authentication request including the biometric information to an authentication server in a case where the biometric information is acquired and transmitting the authentication request including the terminal authentication information to the authentication server in a case where the terminal authentication information is acquired.

The disclosures of the cited prior art documents are incorporated herein by reference. While the example embodiments of the present invention have been particularly shown and described above, the present invention is not limited to these example embodiments. It will be understood by those of ordinary skill in the art that these example embodiments are exemplary only and that various modifications may be made therein without departing from the scope and spirit of the present invention. That is, it goes without saying that the present invention includes various modifications and corrections that can be made by those skilled in the art in accordance with the entire disclosure including the claims and the technical idea.

### REFERENCE SIGNS LIST

10, 102 authentication server
20, 20-1 to 20-3, 103 authentication terminal
30, 101 terminal
201, 301, 401 communication control unit
202 authentication control unit
203 function implementation unit
204 registration request unit
205, 306, 405 storage unit
211 biometric information acquisition unit
212 terminal access unit
213 authentication request unit
302, 402 user registration unit
303 authentication request processing unit
304 registration request processing unit
305 browsing request processing unit
307 behavior history analysis unit
311 processor
312 memory
313 input/output interface
314 communication interface
315 camera
316 card reader
403 browsing request unit
404 output unit

What is claimed is:

1. An authentication system comprising:
a terminal held by a user;
an authentication server that stores first biometric information for performing biometric authentication of the user and first terminal authentication information for performing terminal authentication by the terminal; and
an authentication terminal supporting the biometric authentication and the terminal authentication.

2. The authentication system according to claim 1, wherein the authentication terminal transmits an authentication request including second biometric information of the user to the authentication server.

3. The authentication system according to claim 1, wherein the authentication terminal transmits an authentication request including second terminal authentication information acquired from the terminal to the authentication server.

4. The authentication system according to claim 1, wherein the authentication terminal acquires a desire of the user regarding use of either the biometric authentication or the terminal authentication.

5. The authentication system according to claim 1, wherein
the authentication terminal transmits, to the authentication server, a registration request including an authentication terminal ID assigned to the authentication terminal and detailed information on a behavior of the user in the authentication terminal, and
the authentication server stores the authentication terminal ID and the detailed information in association with each other.

6. The authentication system according to claim 5, wherein
the terminal transmits a browsing request including the authentication terminal ID to the authentication server, and
the authentication server transmits the detailed information associated to the authentication terminal ID to the terminal.

7. The authentication system according to claim 3, wherein the authentication server generates a user ID of the user in response to acquisition of the first biometric information from the user, and stores the generated user ID as the first terminal authentication information.

8. The authentication system according to claim 7, wherein
the authentication server transmits the generated user ID to the terminal, and
the terminal stores the user ID as the second terminal authentication information.

9. The authentication system according to claim 1, wherein the first biometric information is a face image or a feature amount generated from the face image.

10. The authentication system according to claim 3, wherein the terminal stores the second terminal authentication information in an integrated circuit (IC) chip supporting near field communication (NFC).

11. The authentication system according to claim 4, wherein the authentication terminal generates a graphical user interface (GUI) for acquiring the desire of the user regarding use of either the biometric authentication or the terminal authentication.

12. The authentication system according to claim 1, wherein the authentication terminal requests the authentication server to perform authentication by an authentication method supporting either one of the first biometric information and the first terminal authentication information, whichever is acquired earlier.

13. The authentication system according to claim 1, wherein the authentication terminal requests the authentication server to perform authentication by the terminal authentication in a case where the first terminal authentication information can be acquired within a predetermined time after the user is detected.

14. The authentication system according to claim 1, wherein, when the first terminal authentication information is acquired before an authentication result from the biometric authentication is received from the authentication server, the authentication terminal transmits a notification for canceling the authentication by the biometric authentication to the authentication server and requests the authentication server to perform authentication using the acquired first terminal authentication information.

15. The authentication system according to claim 1, wherein the authentication terminal verifies validity of the first biometric information and the first terminal authentication information and determines an authentication method to be requested to the authentication server according to a result of verification of the validity.

16. The authentication system according to claim 5, wherein the authentication server further includes an analyzer configured to analyze an authentication method performed by the authentication terminal using the stored detailed information.

17. The authentication system according to claim 16, wherein the analyzer calculates an implementation ratio of the biometric authentication to the terminal authentication in a predetermined period.

18. An authentication terminal comprising:
at least one memory storing a computer program; and
at least one processor configured to execute the computer program to
acquire biometric information of a user;
access a terminal held by the user and acquire terminal authentication information for performing authentication by the terminal; and
transmit an authentication request including the biometric information to an authentication server in a case where the biometric information is acquired and transmit the authentication request including the terminal authentication information to the authentication server in a case where the terminal authentication information is acquired.

19. A method for controlling an authentication terminal, the method comprising:
in the authentication terminal,
acquiring biometric information of a user;
acquiring terminal authentication information for accessing a terminal held by the user and performing authentication by the terminal; and
transmitting an authentication request including the biometric information to an authentication server when the biometric information is acquired and transmitting the authentication request including the terminal authentication information to the authentication server when the terminal authentication information is acquired.

20. A non-transitory computer-readable storage medium storing a program for causing a computer mounted on an authentication terminal to execute:
a process of acquiring biometric information of a user;
a process of accessing a terminal held by the user and acquiring terminal authentication information for performing authentication by the terminal; and
a process of transmitting an authentication request including the biometric information to an authentication server in a case where the biometric information is acquired and transmitting the authentication request including the terminal authentication information to the authentication server in a case where the terminal authentication information is acquired.

21. A method for controlling an authentication system, the method comprising:
in the authentication system,
storing first biometric information for performing biometric authentication of an user and first terminal authentication information for performing terminal authentication by a terminal held by the user in an authentication server; and
supporting the biometric authentication and the terminal authentication by an authentication terminal.
